(19) United States
(12) Patent Application Publication
(10) Pub. No.: US 2026/0255299 A1
(43) Pub. Date: Aug. 27, 2026

(54) RESOURCE MANAGEMENT FOR COMMUNICATION AND SENSING SERVICES

(71) Applicant: QUALCOMM Incorporated, San Diego, CA (US)

(72) Inventors: Preeti KUMARI, San Diego, CA (US); Hong CHENG, Basking Ridge, NJ (US); Kapil GULATI, Belle Mead, NJ (US); Junyi LI, Greentown, PA (US); Stelios STEFANATOS, San Diego, CA (US); Sony AKKARAKARAN, Poway, CA (US)

(21) Appl. No.: 18/874,912

(22) PCT Filed: Aug. 4, 2023
(86) PCT No.: PCT/US2023/071733

§ 371 Date: Dec. 13, 2024

(30) Foreign Application Priority Data
Sep. 1, 2022 (GR) 20220100718

(51) Int. Cl. H04W 64/00; H04W 72/04; H04W 76/10

(52) U.S. Cl. CPC H04W 64/00; H04W 72/04; H04W 76/10

(57) ABSTRACT

Various aspects of the present disclosure generally relate to wireless communication. In some aspects, a first core network entity may receive a first request associated with initiation of a sensing service associated with a user equipment (UE). The first core network entity may receive, from at least one other core network entity and based at least in part on the first request, one or more sensing session parameters associated with the sensing service. The first core network entity may provide, to a second core network entity and based at least in part on the sensing session parameters, a second request to establish a virtual communication session with the UE, the request including one or more communication session parameters. Numerous other aspects are described.

### CROSS-REFERENCE TO RELATED APPLICATION

This Patent Application claims priority to Greek Patent Application No. 20220100718, filed on Sep. 1, 2022, entitled “RESOURCE MANAGEMENT FOR COMMUNICATION AND SENSING SERVICES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for resource management for communication and sensing services.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first core network entity. The method may include receiving a first request associated with initiation of a sensing service associated with a user equipment (UE). The method may include receiving, from at least one other core network entity and based at least in part on the first request, one or more sensing session parameters associated with the sensing service. The method may include providing, to a second core network entity and based at least in part on the sensing session parameters, a second request to establish a virtual communication session with the UE, the request including one or more communication session parameters.

Some aspects described herein relate to a method of wireless communication performed by a first core network entity. The method may include receiving a first request associated with a communication session associated with a UE, where the first request is associated with one or more first communication session parameters. The method may include receiving, from a second core network entity, a second request to establish a virtual communication session associated with the UE, where the second request is associated with one or more second communication session parameters, and where the virtual communication session corresponds to a sensing service. The method may include providing, to a network node, information indicating the one or more first communication session parameters for the communication session and the one or more second communication session parameters for the virtual communication session.

Some aspects described herein relate to a method of wireless communication performed by a network node. The method may include receiving, from a first core network entity, a first request associated with initiation of a sensing service associated with a UE, where the first request includes information identifying one or more sensing session parameters associated with the sensing service. The method may include determining, based at least in part on the one or more sensing session parameters and one or more communication session parameters associated with a communication session between the UE and the network node, one or more resources for the sensing service. The method may include transmitting, to the UE, information identifying the one or more resources for the sensing service.

Some aspects described herein relate to a first core network entity. The first core network entity may include a memory and one or more processors coupled to the memory. The one or more processors may be configured to receive a first request associated with initiation of a sensing service associated with a UE. The one or more processors may be configured to receive, from at least one other core network entity and based at least in part on the first request, one or more sensing session parameters associated with the sensing service. The one or more processors may be configured to provide, to a second core network entity and based at least in part on the sensing session parameters, a second request to establish a virtual communication session with the UE, the request including one or more communication session parameters.

Some aspects described herein relate to a first core network entity. The first core network entity may include a memory and one or more processors coupled to the memory. The one or more processors may be configured to receive a first request associated with a communication session associated with a UE. The one or more processors may be configured to receive, from a second core network entity, a second request to establish a virtual communication session associated with the UE. The one or more processors may be configured to provide, to a network node, information indicating the one or more first communication session parameters for the communication session and the one or more second communication session parameters for the virtual communication session.

Some aspects described herein relate to a network node. The network node may include a memory and one or more processors coupled to the memory. The one or more processors may be configured to receive, from a first core network entity, a first request associated with initiation of a sensing service associated with a UE. The one or more processors may be configured to determine, based at least in part on the one or more sensing session parameters and one or more communication session parameters associated with a communication session between the UE and the network node, one or more resources for the sensing service. The one or more processors may be configured to transmit, to the UE, information identifying the one or more resources for the sensing service.

Some aspects described herein relate to a non-transitory computer-readable medium that stores a set of instructions by a first core network entity. The set of instructions, when executed by one or more processors of the first core network entity, may cause the first core network entity to receive a first request associated with initiation of a sensing service associated with a UE. The set of instructions, when executed by one or more processors of the first core network entity, may cause the first core network entity to receive, from at least one other core network entity and based at least in part on the first request, one or more sensing session parameters associated with the sensing service. The set of instructions, when executed by one or more processors of the first core network entity, may cause the first core network entity to provide, to a second core network entity and based at least in part on the sensing session parameters, a second request to establish a virtual communication session with the UE, the request including one or more communication session parameters.

Some aspects described herein relate to a non-transitory computer-readable medium that stores a set of instructions by a first core network entity. The set of instructions, when executed by one or more processors of the first core network entity, may cause the first core network entity to receive a first request associated with a communication session associated with a UE. The set of instructions, when executed by one or more processors of the first core network entity, may cause the first core network entity to receive, from a second core network entity, a second request to establish a virtual communication session associated with the UE. The set of instructions, when executed by one or more processors of the first core network entity, may cause the first core network entity to provide, to a network node, information indicating the one or more first communication session parameters for the communication session and the one or more second communication session parameters for the virtual communication session.

Some aspects described herein relate to a non-transitory computer-readable medium that stores a set of instructions by a network node. The set of instructions, when executed by one or more processors of the network node, may cause the network node to receive, from a first core network entity, a first request associated with initiation of a sensing service associated with a UE. The set of instructions, when executed by one or more processors of the network node, may cause the network node to determine, based at least in part on the one or more sensing session parameters and one or more communication session parameters associated with a communication session between the UE and the network node, one or more resources for the sensing service. The set of instructions, when executed by one or more processors of the network node, may cause the network node to transmit, to the UE, information identifying the one or more resources for the sensing service.

Some aspects described herein relate to an apparatus. The apparatus may include means for receiving a first request associated with initiation of a sensing service associated with a UE. The apparatus may include means for receiving, from at least one other core network entity and based at least in part on the first request, one or more sensing session parameters associated with the sensing service. The apparatus may include means for providing, to a second core network entity and based at least in part on the sensing session parameters, a second request to establish a virtual communication session with the UE, the request including one or more communication session parameters.

Some aspects described herein relate to an apparatus. The apparatus may include means for receiving a first request associated with a communication session associated with a UE, where the first request is associated with one or more first communication session parameters. The apparatus may include means for receiving, from a second core network entity, a second request to establish a virtual communication session associated with the UE, where the second request is associated with one or more second communication session parameters, and where the virtual communication session corresponds to a sensing service. The apparatus may include means for providing, to a network node, information indicating the one or more first communication session parameters for the communication session and the one or more second communication session parameters for the virtual communication session.

Some aspects described herein relate to an apparatus. The apparatus may include means for receiving, from a first core network entity, a first request associated with initiation of a sensing service associated with a UE, where the first request includes information identifying one or more sensing session parameters associated with the sensing service. The apparatus may include means for determining, based at least in part on the one or more sensing session parameters and one or more communication session parameters associated with a communication session between the UE and the network node, one or more resources for the sensing service. The apparatus may include means for transmitting, to the UE, information identifying the one or more resources for the sensing service.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram of an example of a core network configured to facilitate wireless communications, in accordance with the present disclosure.

FIG. 5 is a diagram illustrating an example of joint communication and sensing (JCS) systems, in accordance with the present disclosure.

FIG. 6 is a diagram of an example of a core network configured to facilitate resource management for communication and sensing services.

FIG. 7 is a diagram of an example associated with resource management for communication and sensing services by one more core network entities, in accordance with the present disclosure.

FIG. 8 is a diagram of an example associated with resource management for communication and sensing services by a network node, in accordance with the present disclosure.

FIG. 9 is a diagram illustrating an example process performed, for example, by a first core network entity, in accordance with the present disclosure.

FIG. 10 is a diagram illustrating an example process performed, for example, by a first core network entity, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

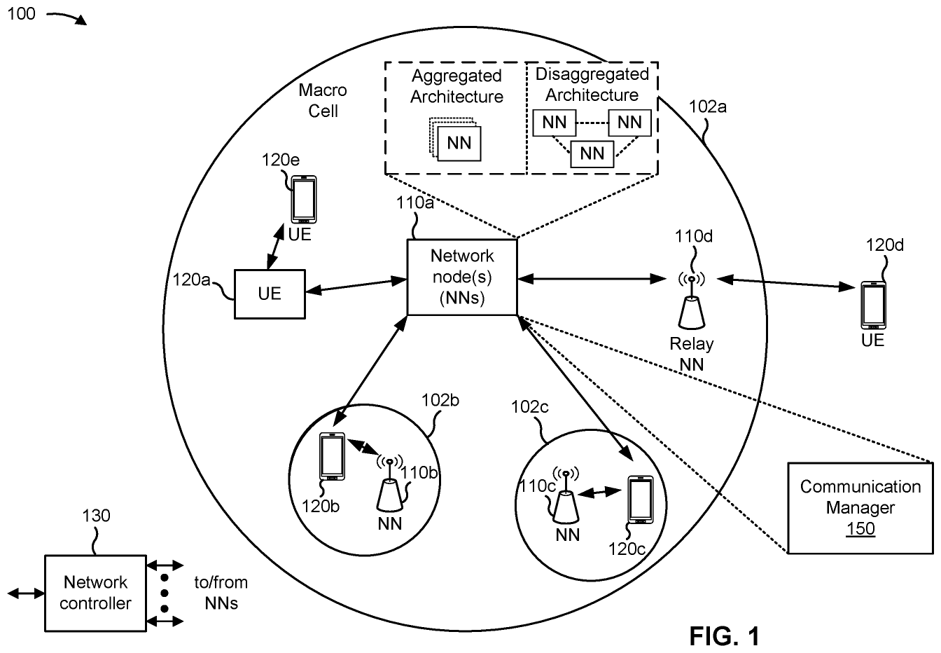

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR 1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHz-300 GHZ). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR 1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node may include a communication manager 150. As described in more detail elsewhere herein, the communication manager 150 may receive, from a first core network entity, a first request associated with initiation of a sensing service associated with a UE, wherein the first request includes information identifying one or more sensing session parameters associated with the sensing service; determine, based at least in part on the one or more sensing session parameters and one or more communication session parameters associated with a communication session between the UE and the network node, one or more resources for the sensing service; and transmit, to the UE, information identifying the one or more resources for the sensing service. Additionally, or alternatively, the communication manager 150 may perform one or more other operations described herein.

As indicated above, FIG. 1 is provided as an example. Other examples may differ from what is described with regard to FIG. 1.

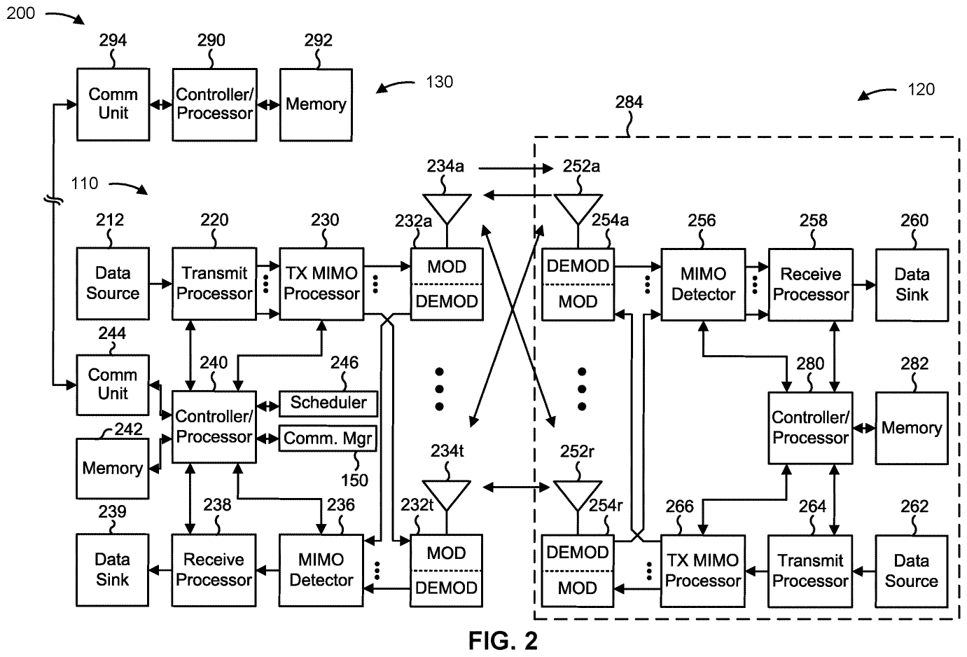

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

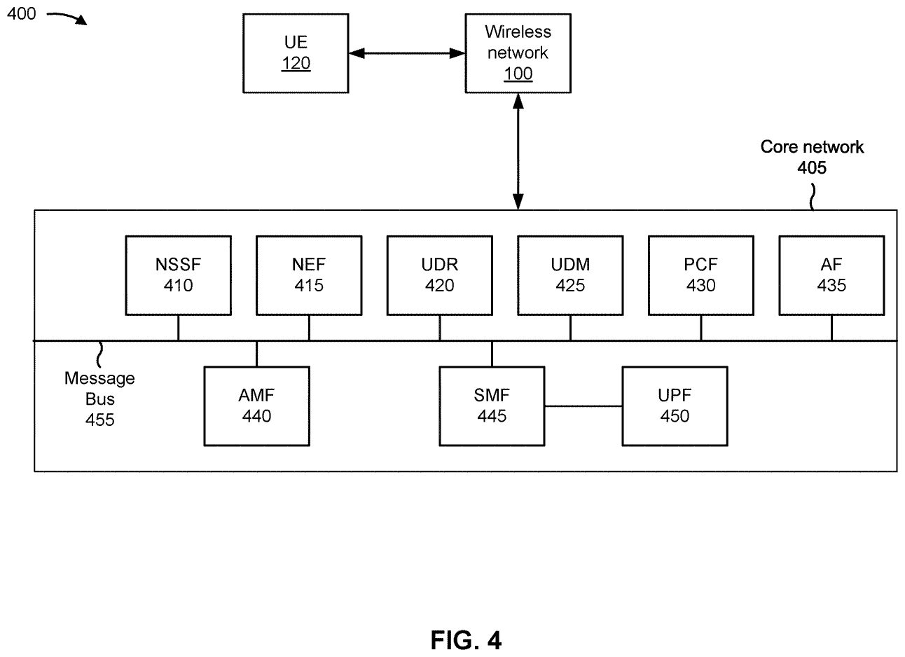

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-13).

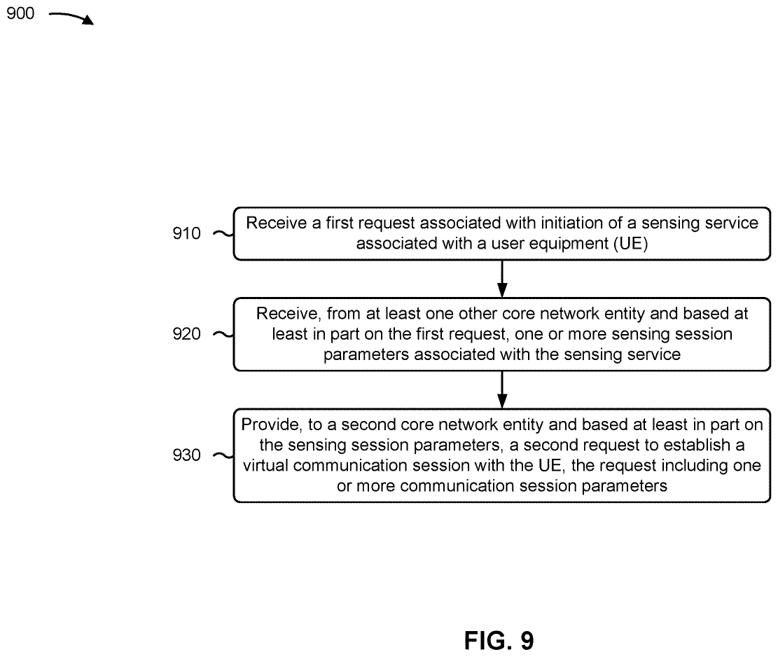

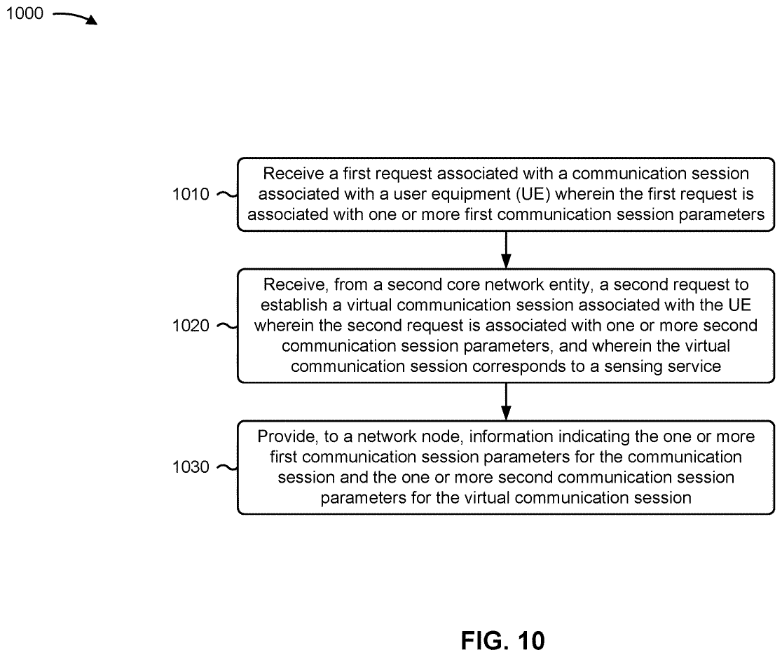

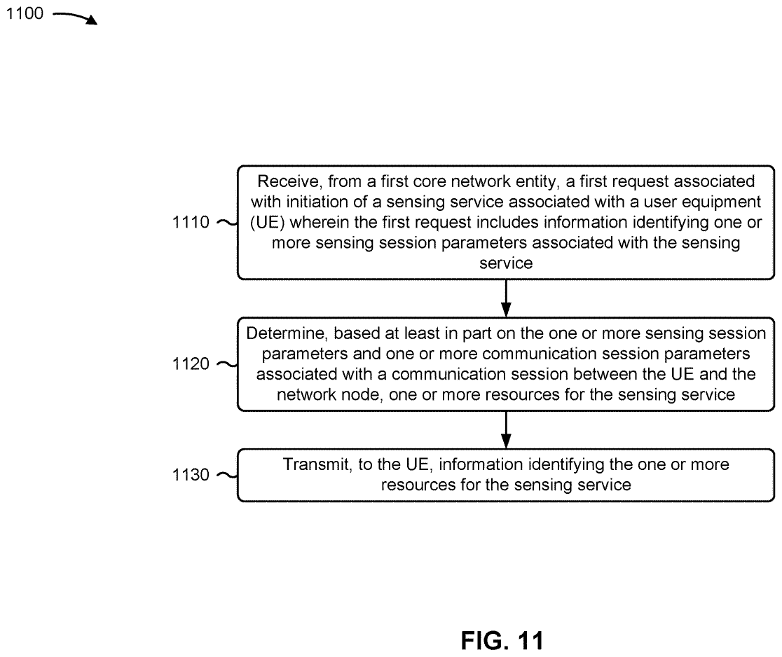

The controller/processor 240 of the network node 110, the controller/processor 280 of the UE 120, and/or any other component(s) of FIG. 2 may perform one or more techniques associated with resource management for communication and sensing services, as described in more detail elsewhere herein. In some aspects, the core network entity described herein is implemented as a network node 110 or includes one or more components of the network node 110 shown in FIG. 2. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the first core network entity includes means for receiving a first request associated with initiation of a sensing service associated with a UE; means for receiving, from at least one other core network entity and based at least in part on the first request, one or more sensing session parameters associated with the sensing service; and/or means for providing, to a second core network entity and based at least in part on the sensing session parameters, a second request to establish a virtual communication session with the UE, the request including one or more communication session parameters. In some aspects, the means for the first core network entity to perform operations described herein may include, for example, one or more of communication manager 1250, transmit processor 220, TX MIMO processor 230, modem 232, antenna 234, MIMO detector 236, receive processor 238, controller/processor 240, memory 242, or scheduler 246.

In some aspects, the first core network entity includes means for receiving a first request associated with a communication session associated with a UE, wherein the first request is associated with one or more first communication session parameters; means for receiving, from a second core network entity, a second request to establish a virtual communication session associated with the UE, wherein the second request is associated with one or more second communication session parameters, and wherein the virtual communication session corresponds to a sensing service; and/or means for providing, to a network node, information indicating the one or more first communication session parameters for the communication session and the one or more second communication session parameters for the virtual communication session. In some aspects, the means for the first core network entity to perform operations described herein may include, for example, one or more of communication manager 1250, transmit processor 220, TX MIMO processor 230, modem 232, antenna 234, MIMO detector 236, receive processor 238, controller/processor 240, memory 242, or scheduler 246

In some aspects, the network node includes means for receiving, from a first core network entity, a first request associated with initiation of a sensing service associated with a UE, wherein the first request includes information identifying one or more sensing session parameters associated with the sensing service; means for determining, based at least in part on the one or more sensing session parameters and one or more communication session parameters associated with a communication session between the UE and the network node, one or more resources for the sensing service; and/or means for transmitting, to the UE, information identifying the one or more resources for the sensing service. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

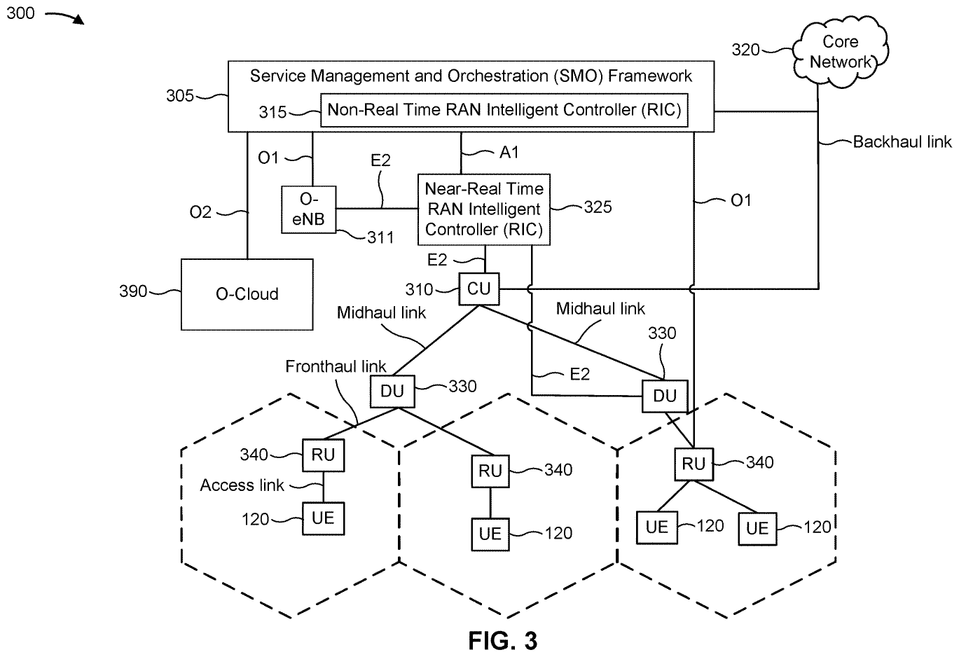

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram of an example 400 of a core network 405 configured to facilitate wireless communications. As shown in FIG. 4, example 400 may include a UE 120, a wireless communication network 100, and a core network 405. Devices, core network entities, and/or networks of example 400 may interconnect via wired connections, wireless connections, or a combination thereof.

The wireless communication network 100 may support, for example, a cellular RAT. The network 100 may include one or more network nodes (e.g., base stations, base transceiver stations, radio base stations, node Bs, eNodeBs (eNBs), gNodeBs (gNBs), base station subsystems, cellular sites, cellular towers, access points, TRPs, radio access nodes, macrocell base stations, microcell base stations, picocell base stations, femtocell base stations, or similar types of devices) and other network entities that can support wireless communication for the UE 120. The network 100 may transfer traffic between the UE 120 (e.g., using a cellular RAT), one or more network nodes (e.g., using a wireless interface or a backhaul interface, such as a wired backhaul interface), and/or the core network 405. The wireless communication network 100 may provide one or more cells that cover geographic areas.

In some aspects, the wireless communication network 100 may perform scheduling and/or resource management for the UE 120 covered by the network 100 (e.g., the UE 120 covered by a cell provided by the wireless communication network 100). In some aspects, the wireless communication network 100 may be controlled or coordinated by a network controller (e.g., network controller 130 of FIG. 1), which may perform load balancing and/or network-level configuration, among other examples. As described above in connection with FIG. 1, the network controller may communicate with the network 100 via a wireless or wireline backhaul. In some aspects, the network 100 may include a network controller, a self-organizing network (SON) module or component, or a similar core network entity, module, or component. Accordingly, the network 100 may perform network control, scheduling, and/or network management functions (e.g., for uplink, downlink, and/or sidelink communications of the UE 120 covered by the network 100).

In some aspects, the core network 405 may include an example functional architecture in which systems and/or methods described herein may be implemented. For example, the core network 405 may include an example architecture of a fifth generation (5G) next generation (NG) core network included in a 5G wireless telecommunications system. Although the example architecture of the core network 405 shown in FIG. 4 may be an example of a service-based architecture, in some aspects, the core network 405 may be implemented as a reference-point architecture and/or a 4G core network, among other examples.

As shown in FIG. 4, the core network 405 may include a number of core network entities identified as functional elements. The core network entities may include, for example, a network slice selection function (NSSF) 410, a network exposure function (NEF) 415, a unified data repository(UDR) 420, a unified data management (UDM) component 425, a policy control function (PCF) 430, an application function (AF) 435, an access and mobility management function (AMF) 440, a session management function (SMF) 445, and/or a user plane function (UPF) 450, among other examples. These core network entities may be communicatively connected via a message bus 455. Each of the core network entities shown in FIG. 4 may be implemented on one or more devices associated with a wireless telecommunications system. In some implementations, one or more of the core network entities may be implemented on physical devices, such as an access point, a base station, and/or a gateway, among other examples. In some implementations, one or more of the core network entities may be implemented on a computing device of a cloud computing environment.

The NSSF 410 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing may efficiently provide communications for different types of services with different service standards.

The NEF 415 may include one or more devices that support exposure of capabilities and/or events in the wireless telecommunications system to help other entities in the wireless telecommunications system discover network services. The UDR 420 may include one or more devices that act as a repository of subscriber information, and other information, which may support various core network entities in the wireless telecommunications system.

The UDM 425 may include one or more devices that store user data and profiles in the wireless telecommunications system. In some aspects, the UDM 425 may be used for fixed access and/or mobile access, among other examples, in the core network 405.

The PCF 430 may include one or more devices that provide a policy framework that incorporates network slicing, roaming, packet processing, and/or mobility management, among other examples.

The AF 435 may include one or more devices that support application influence on traffic routing, access to the NEF 415, and/or policy control, among other examples. The AMF 440 may include one or more devices that act as a termination point for non-access stratum (NAS) signaling and/or mobility management, among other examples.

The SMF 445 may include one or more devices that support the establishment, modification, and release of communication sessions in the wireless telecommunications system. For example, the SMF 445 may configure traffic steering policies at the UPF 450 and/or enforce user equipment internet protocol (IP) address allocation and policies, among other examples.

The UPF 450 may include one or more devices that serve as an anchor point for intraRAT and/or interRAT mobility. In some aspects, the UPF 450 may apply rules to packets, such as rules pertaining to packet routing, traffic reporting, and/or handling user plane QoS, among other examples.

The message bus 455 may be a logical and/or physical communication structure for communication among the functional elements. Accordingly, the message bus 455 may permit communication between two or more functional elements, whether logically (e.g., using one or more application programming interfaces (APIs), among other examples) and/or physically (e.g., using one or more wired and/or wireless connections).

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example 400 may perform one or more functions described as being performed by another set of devices of example environment 400.

As indicated above, FIG. 4 is provided as an example. Other examples may differ from what is described with regard to FIG. 4.

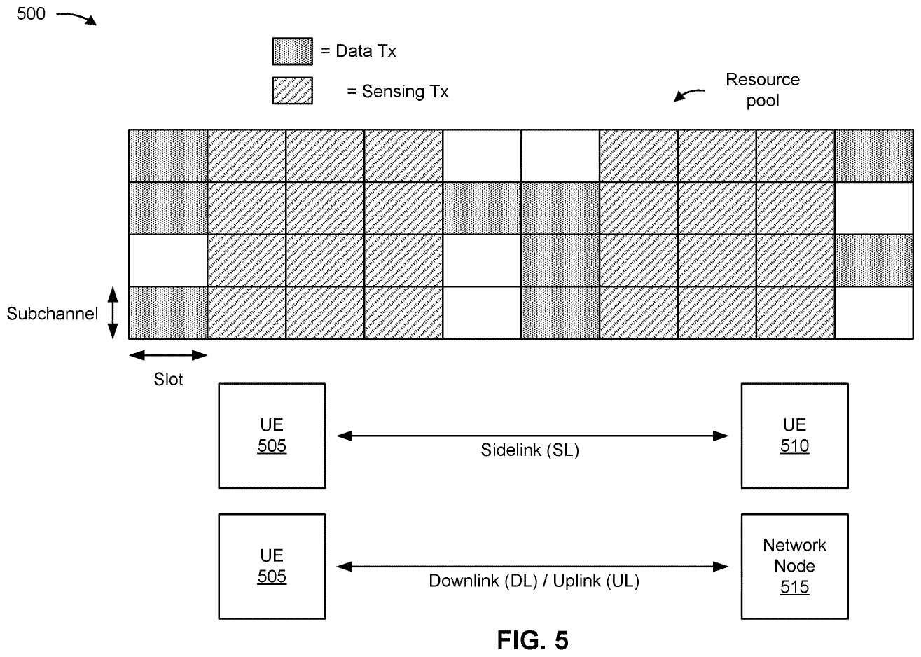

FIG. 5 is a diagram illustrating an example 500 of joint communication and sensing (JCS) systems, in accordance with the present disclosure. As shown in FIG. 5, a UE (e.g., UE 505) may communicate with one or more other UEs (e.g., UE 510) via sidelink and/or one or more network nodes (e.g., network node 515) via downlink and/or uplink.

A UE, such as UE 505, may use RF sensing (e.g., radar sensing) for environmental sensing (e.g., to detect objects). For example, in automotive deployments, a UE associated with a vehicle may transmit one or more sensing transmissions (also referred to as radar transmissions) and measure one or more reflections (e.g., reflections of the sensing transmission off of an object) to determine a distance of an object, a speed of the object, a direction of the object, or an acceleration of the object, among other examples. Reserving dedicated RF resources for radar sensing may result in an inefficient use of RF resources. For example, in cases where few UEs are performing RF sensing, some RF resources may go unused while communication resources are congested with transmissions from many UEs.

Accordingly, some communications systems may integrate wireless communications with RF sensing using a single resource pool for both data and sensing transmissions. In this case, rather than having a first set of resources dedicated for sensing and a second set of resources dedicated for communication, a single set of resources is allocated for both communication and sensing. For example, some techniques may use a 3GPP (e.g., NR) waveform for both communication and sensing, thereby enabling 3GPP devices (e.g., UEs, base stations, roadside units (RSUs), CUs, DUs, RUs, network nodes, or network entities, among other examples) to provide sensing using receive processors, such as receive processor 258 of FIG. 2. A configuration in which both communication and sensing is enabled for a single set of resources may be termed a “joint communication and sensing” or “joint communication and radar” (“JCR”) deployment.

As shown in FIG. 5, a portion of a resource pool is shown, with data transmissions and sensing transmissions occurring over orthogonal resources within the resource pool. As used herein, the transmissions may originate from the same UE (e.g., UE 505), from different UEs, or a combination thereof. In some situations, the transmissions may originate from a network node (e.g., network node 515) for network node-based sensing services. As shown, sensing transmissions may often have a relatively large bandwidth utilization (e.g., relative to the data transmissions), occupying many or all available subchannels and/or resources, and often span more than one slot.

As indicated above, FIG. 5 is provided as an example. Other examples may differ from what is described with respect to FIG. 5.

Core network architecture may support communication-based sessions, but there is currently no support for non-communication-based sessions (e.g., sensing sessions). While JCS operations may be supported by network nodes, the core network does not support coordination or management of sensing and communication sessions. While network nodes do support JCS operations using the communication waveform to perform sensing, JCS generally comes with tradeoffs for communication sessions, such as reduced communication data rate, lower communication spectrum availability (e.g., while sensing is performed in a frequency band). While network nodes may support different sensing operations based on the particular needs of a sensing session, there is currently no framework to control resources in a coordinated manner that accounts for different communication and sensing requirements between the two types of transmissions. This may lead to some sensing and/or communication sessions being allocated insufficient resources (e.g., resources without sufficient bandwidth and/or latency, among other examples), while other sensing and/or communication sessions are allocated too many resources. In addition, sensing and/or communication sessions may be established using parameters (e.g., key performance indicators) that are inefficient for the corresponding application. Different service types may not be prioritized appropriately without a way to coordinate different service types with different priorities. The lack of coordination for resource allocation between different communication and non-communication service types may also result in lower quality, or dropped, communication sessions and/or sensing sessions.

Some techniques and apparatuses described herein enable resource management for communication and sensing services that enable JCS operations with support from the core network. For example, a core network entity may receive a request associated with initiation of a sensing service for a UE, obtain sensing session parameters and policy information from another core network entity, and use the sensing session parameters to establish a virtual communication session with the UE, where the virtual communication session is associated with communication session parameters. As a result, the core network may manage the virtual communication session in a manner similar to that of other communication sessions. This enables sensing services to be associated with quality of service (QoS) parameters that are comparable to QoS parameters of communication services, which may facilitate coordination and management of the different types of services. In this way, a network may allocate resources between communication and non-communication services more efficiently, and in a manner that appropriately prioritizes communication and non-communication services with respect to one another. This may lead to higher quality communication and non-communication sessions, relative to networks using frameworks that lack the ability to manage non-communication sessions as virtual communication sessions, as described herein.

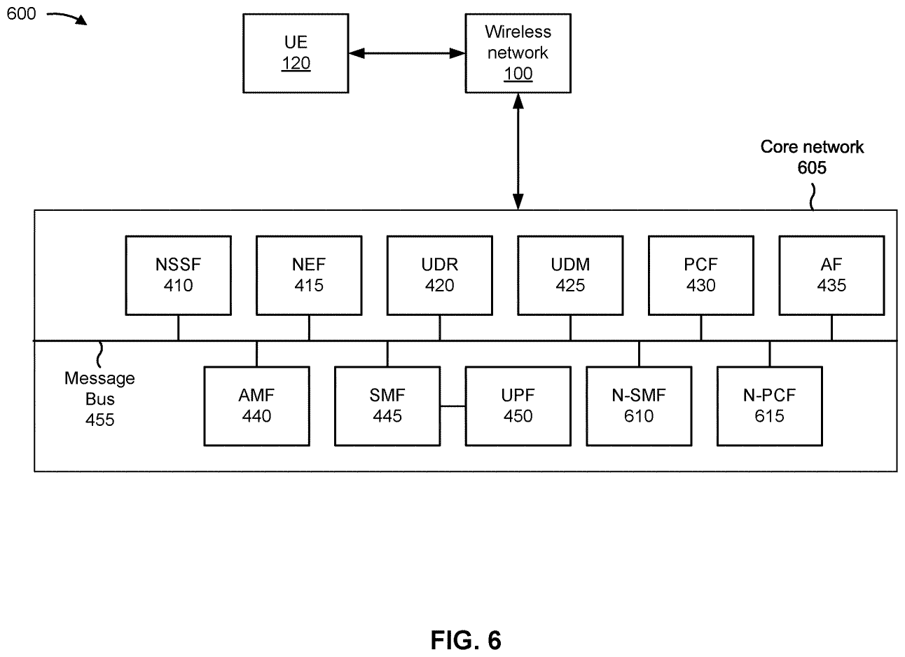

FIG. 6 is a diagram of an example 600 of a core network 605 configured to facilitate resource management for communication and sensing services. As shown in FIG. 6, example 600 may include a UE 120, a wireless communication network 100, and a core network 605. As shown, core network 605 may include many core network entities described herein (e.g., with reference to FIG. 4), such as the NSSF 410, the NEF 415, the UDR 420, the UDM component 425, the PCF 430, the AF 435, the AMF 440, the SMF 445, and/or the UPF 450, among other examples. Core network 605 also includes a non-communication SMF (N-SMF) 610 and a non-communication PCF (N-PCF) 615. Devices, core network entities, and/or networks of example 600 may interconnect via wired connections, wireless connections, or a combination thereof.

The N-SMF 610 may include one or more devices that support the establishment, modification, and release of non-communication sessions (e.g., sensing sessions for radar services and/or positioning services, among other examples) in the wireless telecommunications system. In some aspects, the N-SMF 610 may coordinate with the SMF 445, UDM 425, AMF 440, and/or N-PCF 615 to establish virtual communication sessions for non-communication services. For example, the AMF 440 may receive a request corresponding to a sensing service (e.g., identified based at least in part on a special DNN or access point name (APN) associated with the sensing service) and forward the request to the N-SMF 610. In some aspects, a special slice may be used to indicate the sensing service, such as single network slice selection assistance information (S-NSSAI) specific to the sensing service. The N-SMF 610 may obtain subscription information and/or policy information from the UDM 425 and/or N-PCF 615. In some aspects, the N-SMF 610 may obtain communication session parameters that correspond to the sensing service and coordinate with the SMF 445 and/or AMF 440 to have the sensing service treated as a virtual communication session (e.g., a session that is treated as a session for a communication service).

The N-PCF 615 may include one or more devices that provide a policy framework that may incorporate network slicing, roaming, packet processing, and/or mobility management, among other examples. In some aspects, the N-PCF 615 may coordinate with the N-SMF 610, UDR 420, and/or NEF 415 to establish virtual communication sessions for non-communication services. In some aspects, the N-PCF 615 may obtain policy information associated with the network 100 and/or a UE that requests a sensing service and provide the policy information to the N-SMF 610 for establishing and otherwise managing the sensing service as a virtual communication session.

Operations of the N-SMF 610 and N-PCF 615, as they pertain to managing non-communication sessions as virtual communication sessions, are described further herein. The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of example 600 may perform one or more functions described as being performed by another set of devices of example environment 600.

As indicated above, FIG. 6 is provided as an example. Other examples may differ from what is described with regard to FIG. 6.

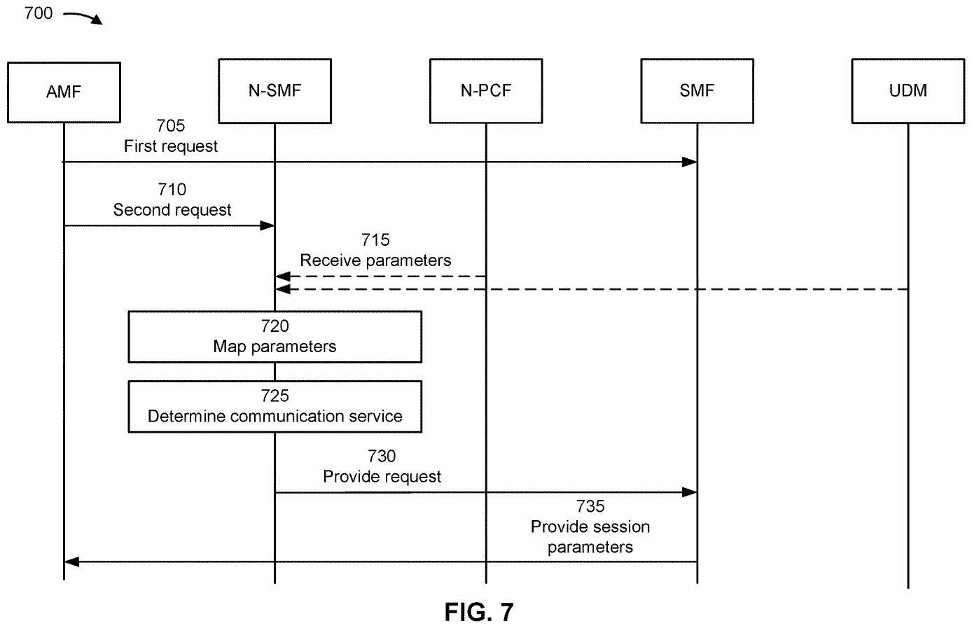

FIG. 7 is a diagram of an example 700 associated with resource management for communication and sensing services by one more core network entities, in accordance with the present disclosure. As shown in FIG. 7, multiple core network entities may communicate with one another (e.g., AMF 440, N-SMF 610, N-PCF 615, SMF 445, and UDM 425). In some aspects, the core network entities may be part of a wireless network (e.g., wireless network 100) to which one or more network nodes and/or UEs (not shown) may have connected (e.g., via AMF 440) prior to operations shown in FIG. 7.

As shown by reference number 705, the AMF may transmit, and the SMF may receive, a first request associated with a communication session associated with a UE. For example, when establishing a communications session, the AMF may communicate with the SMF, and other core network entities, to establish QoS flows, and/or QoS rules, among other examples, for the communications session. In some aspects, the first request may be associated with one or more first communication session parameters. For example, the first communication session parameters may include a quality of service parameter, a signal-to-interference-plus-noise ratio (SINR) parameter, a data rate parameter, and/or a latency parameter, among other examples.

As shown by reference number 710, the AMF may transmit, and the N-SMF may receive, a second request associated with initiation of a sensing service associated with the UE. For example, in addition to the request for the communication session, the UE may request resources for a sensing service. By way of example, a UE that requests resources for a V2X communication session may also request resources for a sensing service for positioning and/or collision avoidance, among other examples.

In some aspects, the second request may be associated with a sensing network slice that indicates the second request is for the sensing service. For example, separate network slices may be used for sensing traffic and communications traffic. In some aspects, the second request may be associated with a dynamic network name (DNN) or APN that indicates the second request is for the sensing service.

As shown by reference number 715, the N-PCF and/or the UDM may provide, and the N-SMF may obtain, one or more sensing session parameters associated with the sensing service. In some aspects, the sensing session parameters are based at least in part on subscription information associated with the UE and the sensing service and/or policy information associated with the sensing service, among other examples. The subscription information and policy information may indicate which types of sensing services are available for the UE as well as various QoS parameters and/or limitations (e.g., subscriber or network-based limitations) for sensing services.

In some aspects, the N-SMF may receive, and the N-PCF may provide, information indicating one or more policies for managing the sensing service, which may be based at least in part on information that identifies a location of the UE. For example, the AMF (or a network node) may provide information indicating the location of the UE, and the SMF may be configured to determine sensing session parameters based at least in part on the location of the UE, enabling the N-SMF to adjust various parameters in situations where resources are expected to be more or less limited than in other locations.

In some aspects, the one or more sensing session parameters may include at least one of: a sensing type parameter (e.g., radar, ranging, and/or positioning, among other examples), a range parameter (e.g., a range in meters, such as a 10-300 meter (m) range), a range resolution parameter (e.g., resolution within a particular measurement, such as <1 m, <0.1 m, <1 centimeter (cm)), a velocity parameter (e.g., a velocity in meters/second (m/s), such as −75 to 60 m/s), a velocity resolution parameter (e.g., resolution within a particular measurement, such as <1 m/s or <0.5 m/s), an azimuth field of view parameter (e.g., azimuth field of view from −15 to +15 degrees), an angular resolution parameter (e.g., resolution within a particular measurement, such as <4 degrees, <1 degree, or <0.5 degrees), a maximum number of detected targets (e.g., an absolute number of targets/objects detected, such as 12, 20, 32, or 64), a data rate parameter (e.g., a rate in megabits/second (Mbps) or gigabits/second (Gbps)), and/or a latency parameter (e.g., measured in milliseconds (ms), such as 100 ms). The foregoing sensing session parameters are examples, and the type and range of the parameters may depend on the type of sensing service, UE capabilities, and/or network capabilities, among other examples.

In some aspects, the sensing session parameters may be based at least in part on the second request. For example, the second request may include requested sensing parameters that the UE is requesting for a particular sensing application (e.g., collision avoidance, ranging, and/or positioning, among other examples). In some aspects, the sensing session parameters may be based on a combination of the parameters requested by the UE and the subscription and/or policy information from the other core network entities. For example, the N-SMF may use the requested sensing parameters, as long as they satisfy any limits identified by the subscription and/or policy information. For requested sensing parameters that do not meet the limits, the N-SMF may select the best available sensing session parameters indicated by the subscription and/or policy information.

As shown by reference number 720, the N-SMF may map the one or more sensing session parameters to the one or more communication session parameters. In some aspects, the N-SMF may use information that maps sensing session parameters to communication sensing parameters to obtain communication session parameters that can be used to treat the sensing service as a virtual communication session. For example, sensing parameters, such as a sensing type parameter, a range parameter, a range resolution parameter, a velocity parameter, a velocity resolution parameter, an azimuth field of view parameter, an angular resolution parameter, a maximum number of detected targets, a data rate parameter, and/or a latency parameter may be mapped to communications parameters, such as a QoS parameter, an SINR parameter, a data rate parameter, and/or a latency parameter, among other examples. By mapping, or translating, the sensing parameters to communication parameters, the N-SMF may treat a sensing session as if it were a communication session (e.g., a virtual communication session) for the purpose of scheduling, coordination, and management of the sensing service with other communication sessions and/or services.

As shown by reference number 725, the N-SMF may determine, based at least in part on the sensing session parameters, a communication service type for the virtual communication session. For example, the N-SMF may determine that a ranging service used to support a remote driving application can be handled together with or as a V2X and/or unmanned autonomous vehicle (UAV) communication session. In some aspects, the sensing session parameters may indicate, and/or map to, a corresponding communication service type.

As shown by reference number 730, the N-SMF may provide, and the SMF may receive, a third request to establish a virtual communication session with the UE. The request may include second communication session parameters, such as the communication session parameters that were derived from the sensing session parameters (e.g., as described herein). The SMF may already have first communication session parameters for the communication session. The first and second communication session parameters may enable the SMF, which is already handling a communication session for the UE, to handle the virtual communication session alongside the communication session. In some aspects, the SMF may determine QoS parameters for the communication session and the virtual communication session based on their corresponding parameters.

As shown by reference number 735, the SMF may provide information indicating the first communication session parameters for the communication session and the second communication session parameters for the virtual communication session. For example, the parameters may be provided to a network node via the AMF. In some aspects, the actual resource allocation may be left to the network node to determine, based on the communication session parameters. This may enable a network node, for example, to use communication session parameters, such as QoS parameters, to manage both a communication-based session (e.g., a V2X/UAV communication session) and a non-communication-based session (e.g., a sensing service, such as a ranging service).

In some aspects, the SMF and/or the N-SMF may provide, for a network node associated with the UE, embedded radio level operation configuration information in a sensing session specific container. For example, the SMF and/or N-SMF may provide the network node with configuration information, associated with the communication session parameters and/or the sensing session parameters, for the communication session and/or the virtual communication session via the AMF.

In some aspects, the N-SMF may provide the embedded radio level operation configuration information to the SMF, which may in turn provide the embedded radio level operation configuration information to the network node (e.g., via the AMF).

In some aspects, the SMF may provide, to the network node (e.g., via the AMF), sensing information indicating that the virtual communication session is for the sensing service to be established between the network node and the UE.

As indicated above, FIG. 7 is provided as an example. Other examples may differ from what is described with respect to FIG. 7.

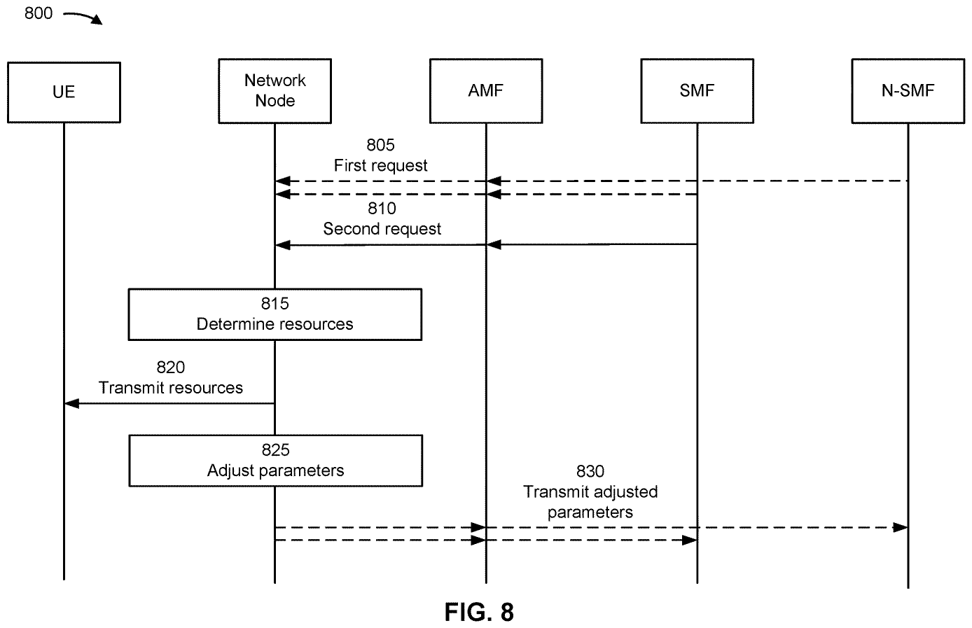

FIG. 8 is a diagram of an example 800 associated with resource management for communication and sensing services by a network node, in accordance with the present disclosure. As shown in FIG. 8, multiple core network entities may communicate with one another (e.g., AMF 440, N-SMF 610, and SMF 445), with a network node (e.g., network node 110), and/or with a UE (e.g., UE 120). In some aspects, the UE, the network node, and the core network entities may be part of a wireless network (e.g., wireless network 100) to which the network node and the UE may have connected (e.g., via AMF 440) prior to operations shown in FIG. 8.

As shown by reference number 805, the N-SMF and/or SMF may provide, and the network node may receive, a first request associated with initiation of a sensing service associated with a UE. For example, the N-SMF may have previously received information indicating a request for the sensing service and be providing the network node with the first request based at least in part on subscription and/or policy information relevant to the UE, the network, and/or the sensing service. In some aspects, the first request may include information identifying one or more sensing session parameters associated with the sensing service. For example, rather than providing the network node with communication session parameters (e.g., as a virtual communication session), the N-SMF may provide the network node with the sensing session parameters to enable the network node to treat the sensing service as a virtual communication session. In some aspects, the N-SMF may provide the first request to the network node via the AMF and/or SMF (e.g., as a virtual communication session).

In some aspects, the first request may include information indicating whether the sensing service is for a radar service, a positioning service, or another type of sensing service. The first request may also include information indicating whether the sensing service is for UE-based sensing or network node-based sensing. UE-based sensing may include services where a UE transmits sensing signals, while a network node-based sensing service may include services where a network node transmits sensing signals. In some aspects, the first request includes information indicating a priority associated with the sensing service.

As shown by reference number 810, the SMF may provide (e.g., via the AMF), and the network node may receive, a second request including one or more communication session parameters. The communication session parameters may include any of the communication session parameters described herein for managing a communication session (e.g., QoS parameters).

As shown by reference number 815, the network node may determine, based at least in part on the one or more sensing session parameters and one or more communication session parameters associated with a communication session between the UE and the network node, one or more resources for the sensing service. The one or more resources for the sensing service may be JCS resources associated with the communication session.

In some aspects, the network node may determine the one or more resources based at least in part on other resources associated with at least one other sensing service associated with at least one other UE or network node. For example, other UEs and/or network nodes may have active sensing sessions around which the network node may determine the one or more resources. In some aspects, the one or more resources for the sensing service are associated with a first frequency range (e.g., FR 2), and wherein one or more other resources for the communication session are associated with a second frequency range (e.g., FR 1).

In some aspects, the network node may determine a first portion of JCS resources for the sensing service, determine a second portion of the JCS resources for the communication session, and determine, as the one or more resources (e.g., for the sensing service), the first portion of the JCS resources. For example, if 100 Mbps can be achieved for a given resource: 80 Mbps equivalent resource can be allocated to the communication session, and 20 Mbps can be allocated to the virtual communication session with some waveform parameters optimized for sensing. The lower data rate waveform may have a higher sensing performance, for example, due to a large cyclic prefix, or guard intervals, and/or low digital-to-analog converter and/or analog-to-digital converter needs, among other examples.

In some aspects, the separation of resources may be achieved using a mixed bearer for both communication and sensing needs. Separate bearers may be used for communication and sensing, for example, where only one service needs to be satisfied urgently. For example, if 100 Mbps can be achieved for a given resource, the network node may either communicate with 100 Mbps or perform sensing with highly accurate object detection and tracking. The priority of the bearer may depend on the latency parameter of the sensing service or communication service. For example, a pre-crash radar application may have a higher priority than, and be scheduled before, a communication for virtual reality gaming.

As shown by reference number 820, the network node may transmit, to the UE, information identifying the one or more resources for the sensing service. For example, after allocating resources between the communication and sensing services, the network node may transmit, to the UE, information indicating the resource allocation for each service, to enable the UE to transmit and/or receive using the resource allocation. In some aspects, the network node may transmit, to the UE and based at least in part on the one or more sensing session parameters, one or more beam parameters to be used for the sensing service. For example, different beam parameters, such as beam width, may be preferable for certain sensing services.

As shown by reference number 825, the network node may adjust the one or more sensing parameters. For example, depending on resource requirements for the communication session, or for other communication and/or sensing sessions, the priority of the sensing session (e.g., the virtual communication session) may change relative to the other sessions. In this situation, the network node may adjust a resource allocation for the sensing session and/or adjust the one or more sensing parameters associated with the sensing session.

As shown by reference number 830, the network node may transmit, to the SMF or N-SMF, information indicating an adjustment to the one or more sensing session parameters. For example, in a situation where the sensing session parameters have changed, the SMF and/or N-SMF may be informed, to enable the SMF and/or N-SMF to coordinate future communication and sensing sessions.

As indicated above, FIG. 8 is provided as an example. Other examples may differ from what is described with respect to FIG. 8.

As described herein, the core network may manage a virtual communication session in a manner similar to that of other communication sessions. This enables sensing services to be associated with QoS parameters that are comparable to QoS parameters of communication services, which may facilitate coordination and management of the different types of services. In this way, a network may allocate resources between communication and non-communication services more efficiently, and in a manner that appropriately prioritizes communication and non-communication services with respect to one another. This may lead to higher quality communication and non-communication sessions, relative to networks using frameworks that lack the ability to manage non-communication sessions as virtual communication sessions, as described herein.

FIG. 9 is a diagram illustrating an example process 900 performed, for example, by a first core network entity, in accordance with the present disclosure. Example process 900 is an example where the first core network entity (e.g., N-SMF 610) performs operations associated with resource management for communication and sensing services.

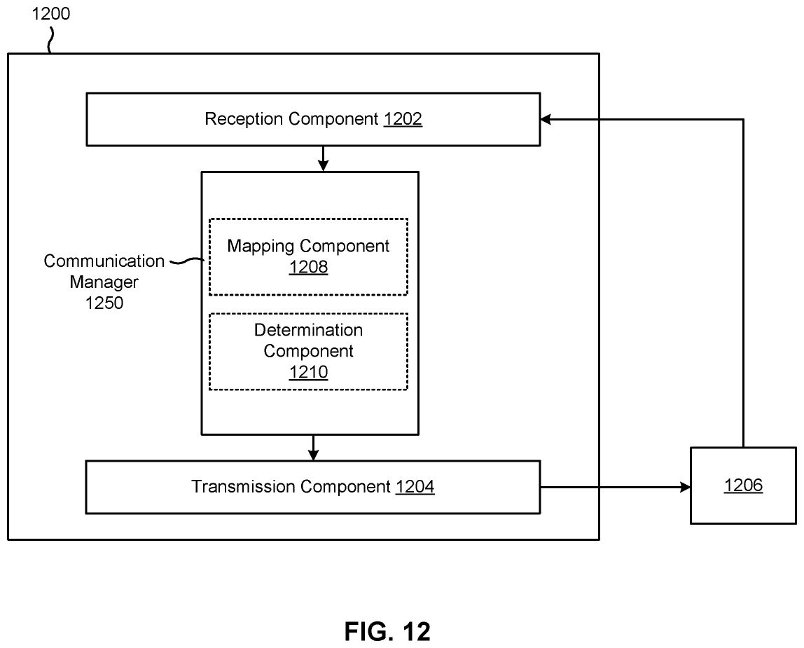

As shown in FIG. 9, in some aspects, process 900 may include receiving a first request associated with initiation of a sensing service associated with a UE (block 910). For example, the first core network entity (e.g., using communication manager 1250 and/or reception component 1202, depicted in FIG. 12) may receive a first request associated with initiation of a sensing service associated with a UE, as described above.

As further shown in FIG. 9, in some aspects, process 900 may include receiving, from at least one other core network entity and based at least in part on the first request, one or more sensing session parameters associated with the sensing service (block 920). For example, the first core network entity (e.g., using communication manager 1250 and/or reception component 1202, depicted in FIG. 12) may receive, from at least one other core network entity and based at least in part on the first request, one or more sensing session parameters associated with the sensing service, as described above.

As further shown in FIG. 9, in some aspects, process 900 may include providing, to a second core network entity and based at least in part on the sensing session parameters, a second request to establish a virtual communication session with the UE, the request including one or more communication session parameters (block 930). For example, the first core network entity (e.g., using communication manager 1250 and/or transmission component 1204, depicted in FIG. 12) may provide, to a second core network entity and based at least in part on the sensing session parameters, a second request to establish a virtual communication session with the UE, the request including one or more communication session parameters, as described above.

Process 900 may include additional aspects, such as any single aspect or any combination of aspects described below and/or in connection with one or more other processes described elsewhere herein.

In a first aspect, process 900 includes mapping the one or more sensing session parameters to the one or more communication session parameters.

In a second aspect, alone or in combination with the first aspect, the one or more sensing session parameters include at least one of a sensing type parameter, a range parameter, a range resolution parameter, a velocity parameter, a velocity resolution parameter, an azimuth field of view parameter, an angular resolution parameter, a maximum number of detected targets, a data rate parameter, or a latency parameter.

In a third aspect, alone or in combination with one or more of the first and second aspects, the one or more communication session parameters include at least one of a quality of service parameter, an SINR parameter, a data rate parameter, or a latency parameter.

In a fourth aspect, alone or in combination with one or more of the first through third aspects, the one or more sensing session parameters are based at least in part on at least one of information associated with the UE and the sensing service, or policy information associated with the sensing service.

In a fifth aspect, alone or in combination with one or more of the first through fourth aspects, the first core network entity comprises an N-SMF, and the second core network entity comprises an SMF.

In a sixth aspect, alone or in combination with one or more of the first through fifth aspects, the at least one other core network entity comprises at least one of an N-PCF, or a UDM.

In a seventh aspect, alone or in combination with one or more of the first through sixth aspects, the first request is received from an AMF.

In an eighth aspect, alone or in combination with one or more of the first through seventh aspects, the first request is associated with a sensing network slice that indicates the first request is for the sensing service.

In a ninth aspect, alone or in combination with one or more of the first through eighth aspects, the first request is associated with a DNN or APN that indicates the first request is for the sensing service.

In a tenth aspect, alone or in combination with one or more of the first through ninth aspects, receiving the one or more sensing session parameters comprises receiving information indicating one or more policies for managing the sensing service.

In an eleventh aspect, alone or in combination with one or more of the first through tenth aspects, the information indicating the one or more policies is based at least in part on information that identifies a location of the UE.

In an eleventh aspect, alone or in combination with one or more of the first through tenth aspects, the information indicating the one or more policies is received from an N-PCF entity.

In a twelfth aspect, alone or in combination with one or more of the first through eleventh aspects, process 900 includes determining, based at least in part on the sensing session parameters, a communication service type for the virtual communication session, and indicating, to the second core network entity, that the virtual communication session is associated with the communication service type.

In a thirteenth aspect, alone or in combination with one or more of the first through twelfth aspects, the communication service type is associated with at least one of V2X communications, or UAV communications.

In a fourteenth aspect, alone or in combination with one or more of the first through thirteenth aspects, process 900 includes providing, for a network node associated with the UE, embedded radio level operation configuration information in a sensing session specific container.

In a fifteenth aspect, alone or in combination with one or more of the first through fourteenth aspects, process 900 includes providing, to a network node, a third request to establish the sensing service between the network node and the UE.

In a sixteenth aspect, alone or in combination with one or more of the first through fifteenth aspects, the third request includes information indicating whether the sensing service is for a radar service or positioning service.

In a seventeenth aspect, alone or in combination with one or more of the first through sixteenth aspects, the third request includes information indicating the one or more sensing session parameters.

In an eighteenth aspect, alone or in combination with one or more of the first through seventeenth aspects, the third request includes information indicating whether the sensing service is for UE-based sensing or network node-based sensing.

In a nineteenth aspect, alone or in combination with one or more of the first through eighteenth aspects, the third request includes information indicating a priority associated with the sensing service.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a first core network entity, in accordance with the present disclosure. Example process 1000 is an example where the first core network entity (e.g., an SMF 445) performs operations associated with resource management for communication and sensing services.

As shown in FIG. 10, in some aspects, process 1000 may include receiving a first request associated with a communication session associated with a UE, wherein the first request is associated with one or more first communication session parameters (block 1010). For example, the first core network entity (e.g., using communication manager 1250 and/or reception component 1202, depicted in FIG. 12) may receive a first request associated with a communication session associated with a UE, wherein the first request is associated with one or more first communication session parameters, as described above. In some aspects, the first request is associated with one or more first communication session parameters.

As further shown in FIG. 10, in some aspects, process 1000 may include receiving, from a second core network entity, a second request to establish a virtual communication session associated with the UE, wherein the second request is associated with one or more second communication session parameters, and wherein the virtual communication session corresponds to a sensing service (block 1020). For example, the first core network entity (e.g., using communication manager 1250 and/or reception component 1202, depicted in FIG. 12) may receive, from a second core network entity, a second request to establish a virtual communication session associated with the UE, wherein the second request is associated with one or more second communication session parameters, and wherein the virtual communication session corresponds to a sensing service, as described above. In some aspects, the second request is associated with one or more second communication session parameters. In some aspects, the virtual communication session corresponds to a sensing service.

As further shown in FIG. 10, in some aspects, process 1000 may include providing, to a network node, information indicating the one or more first communication session parameters for the communication session and the one or more second communication session parameters for the virtual communication session (block 1030). For example, the first core network entity (e.g., using communication manager 1250 and/or transmission component 1204, depicted in FIG. 12) may provide, to a network node, information indicating the one or more first communication session parameters for the communication session and the one or more second communication session parameters for the virtual communication session, as described above.

Process 1000 may include additional aspects, such as any single aspect or any combination of aspects described below and/or in connection with one or more other processes described elsewhere herein.

In a first aspect, process 1000 includes receiving, from the second core network entity and embedded in a sensing session specific container, radio level operation configuration information for the network node, and providing, to the network node, the radio level operation configuration information.

In a second aspect, alone or in combination with the first aspect, the radio level operation configuration information is associated with at least one sensing session parameters, the at least one sensing session parameters including at least one of a sensing type parameter, a range parameter, a range resolution parameter, a velocity parameter, a velocity resolution parameter, an azimuth field of view parameter, an angular resolution parameter, a maximum number of detected targets, a data rate parameter, or a latency parameter.

In a third aspect, alone or in combination with one or more of the first and second aspects, the one or more second communication session parameters include at least one of a quality of service parameter, an SINR parameter, a data rate parameter, or a latency parameter.

In a fourth aspect, alone or in combination with one or more of the first through third aspects, the one or more second communication session parameters are based at least in part on at least one of information associated with the UE and the sensing service, or policy information associated with the sensing service.

In a fifth aspect, alone or in combination with one or more of the first through fourth aspects, the first core network entity comprises an SMF, and the second core network entity comprises an N-SMF entity.

In a sixth aspect, alone or in combination with one or more of the first through fifth aspects, the first request is received from an AMF entity.

In a seventh aspect, alone or in combination with one or more of the first through sixth aspects, the second request is associated with a sensing network slice that indicates the second request is for the sensing service.

In an eighth aspect, alone or in combination with one or more of the first through seventh aspects, the second request is associated with a DNN or APN that indicates the second request is for the sensing service.

In a ninth aspect, alone or in combination with one or more of the first through eighth aspects, process 1000 includes receiving information indicating one or more policies for managing the virtual communication session as the sensing service.

In a tenth aspect, alone or in combination with one or more of the first through ninth aspects, the second request is associated with information indicating that the virtual communication session is associated with a communication service type.

In an eleventh aspect, alone or in combination with one or more of the first through tenth aspects, the communication service type is associated with at least one of V2X communications, or UAV communications.

In a twelfth aspect, alone or in combination with one or more of the first through eleventh aspects, process 1000 includes providing, to the network node, sensing information indicating that the virtual communication session is for the sensing service, to be established between the network node and the UE.

In a thirteenth aspect, alone or in combination with one or more of the first through twelfth aspects, the sensing information includes information indicating whether the sensing service is for a radar service or positioning service.

In a fourteenth aspect, alone or in combination with one or more of the first through thirteenth aspects, the sensing information includes information indicating one or more sensing session parameters.

In a fifteenth aspect, alone or in combination with one or more of the first through fourteenth aspects, the sensing information includes information indicating whether the sensing service is for UE-based sensing or network node-based sensing.

In a sixteenth aspect, alone or in combination with one or more of the first through fifteenth aspects, the sensing information includes information indicating a priority associated with the sensing service.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with resource management for communication and sensing services.

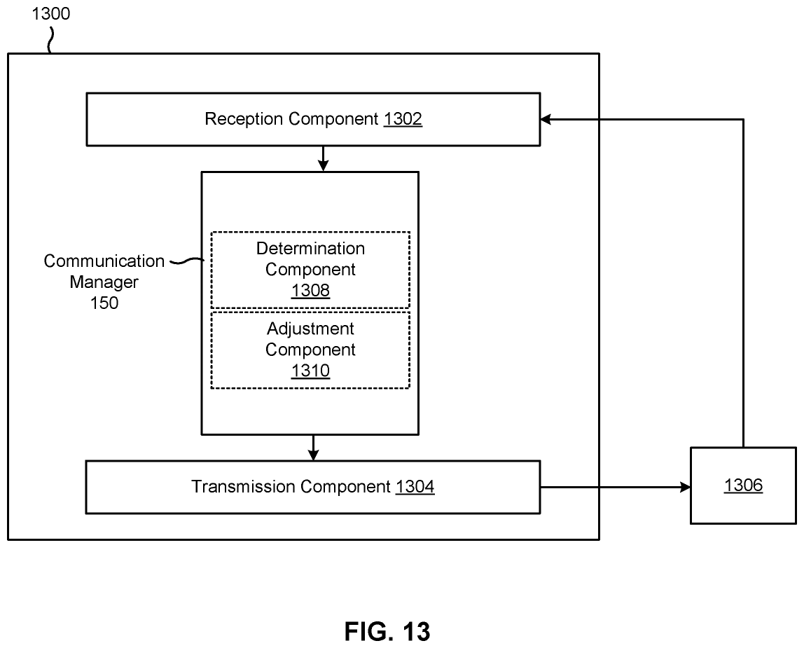

As shown in FIG. 11, in some aspects, process 1100 may include receiving, from a first core network entity, a first request associated with initiation of a sensing service associated with a UE, wherein the first request includes information identifying one or more sensing session parameters associated with the sensing service (block 1110). For example, the network node (e.g., using communication manager 150 and/or reception component 1302, depicted in FIG. 13) may receive, from a first core network entity, a first request associated with initiation of a sensing service associated with a UE, wherein the first request includes information identifying one or more sensing session parameters associated with the sensing service, as described above. In some aspects, the first request includes information identifying one or more sensing session parameters associated with the sensing service.

As further shown in FIG. 11, in some aspects, process 1100 may include determining, based at least in part on the one or more sensing session parameters and one or more communication session parameters associated with a communication session between the UE and the network node, one or more resources for the sensing service (block 1120). For example, the network node (e.g., using communication manager 150 and/or determination component 1308, depicted in FIG. 13) may determine, based at least in part on the one or more sensing session parameters and one or more communication session parameters associated with a communication session between the UE and the network node, one or more resources for the sensing service, as described above.

As further shown in FIG. 11, in some aspects, process 1100 may include transmitting, to the UE, information identifying the one or more resources for the sensing service (block 1130). For example, the network node (e.g., using communication manager 150 and/or transmission component 1304, depicted in FIG. 13) may transmit, to the UE, information identifying the one or more resources for the sensing service, as described above.

Process 1100 may include additional aspects, such as any single aspect or any combination of aspects described below and/or in connection with one or more other processes described elsewhere herein.

In a first aspect, process 1100 includes receiving, from a second core network entity, a second request including the one or more communication session parameters.

In a second aspect, alone or in combination with the first aspect, the first core network entity is an N-SMF, and the second core network entity is an SMF entity.

In a third aspect, alone or in combination with one or more of the first and second aspects, the one or more resources for the sensing service are associated with a first frequency range, and wherein one or more other resources for the communication session are associated with a second frequency range.

In a fourth aspect, alone or in combination with one or more of the first through third aspects, determining the one or more resources for the sensing service comprises determining the one or more resources based at least in part on other resources associated with at least one other sensing service associated with at least one other UE.

In a fifth aspect, alone or in combination with one or more of the first through fourth aspects, process 1100 includes transmitting, to the UE and based at least in part on the one or more sensing session parameters, one or more beam parameters to be used for the sensing service.

In a sixth aspect, alone or in combination with one or more of the first through fifth aspects, the one or more resources for the sensing service are joint communication and sensing resources associated with the communication session.

In a seventh aspect, alone or in combination with one or more of the first through sixth aspects, process 1100 includes adjusting the one or more sensing session parameters, and transmitting, to at least one of the first core network entity or a second core network entity, information indicating an adjustment to the one or more sensing session parameters.

In an eighth aspect, alone or in combination with one or more of the first through seventh aspects, determining the one or more resources comprises determining a first portion of joint communication and sensing resources for the sensing service, determining a second portion of the joint communication and sensing resources for the communication session, and determining, as the one or more resources, the first portion of the joint communication and sensing resources.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a core network entity, or a core network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1250. The communication manager 1250 may include one or more of a mapping component 1208 or a determination component 1210, among other examples.

In some aspects, the communication manager 1250 may receive a first request associated with initiation of a sensing service associated with a UE; receive, from at least one other core network entity and based at least in part on the first request, one or more sensing session parameters associated with the sensing service; and provide, to a second core network entity and based at least in part on the sensing session parameters, a second request to establish a virtual communication session with the UE, the request including one or more communication session parameters. In some aspects, the communication manager 1250 may receive a first request associated with a communication session associated with a UE, wherein the first request is associated with one or more first communication session parameters; receive, from a second core network entity, a second request to establish a virtual communication session associated with the UE, wherein the second request is associated with one or more second communication session parameters, and wherein the virtual communication session corresponds to a sensing service; and provide, to a network node, information indicating the one or more first communication session parameters for the communication session and the one or more second communication session parameters for the virtual communication session. Additionally, or alternatively, the communication manager 1250 may perform one or more other operations described herein.

In some aspects, the apparatus 1200 may be configured to perform one or more operations described herein in connection with FIGS. 4-8. Additionally, or alternatively, the apparatus 1200 may be configured to perform one or more processes described herein, such as process 900 of FIG. 9, process 1000 of FIG. 10, or a combination thereof. In some aspects, the apparatus 1200 and/or one or more components shown in FIG. 12 may include one or more components of the core network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the core network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the core network entity described in connection with FIG. 2. In some aspects, the transmission component 1204 may be co-located with the reception component 1202 in a transceiver.

The reception component 1202 may receive a first request associated with initiation of a sensing service associated with a UE. The reception component 1202 may receive, from at least one other core network entity and based at least in part on the first request, one or more sensing session parameters associated with the sensing service. The transmission component 1204 may provide, to a second core network entity and based at least in part on the sensing session parameters, a second request to establish a virtual communication session with the UE, the request including one or more communication session parameters.

The mapping component 1208 may map the one or more sensing session parameters to the one or more communication session parameters.

The determination component 1210 may determine, based at least in part on the sensing session parameters, a communication service type for the virtual communication session.

The transmission component 1204 may indicate, to the second core network entity, that the virtual communication session is associated with the communication service type.

The transmission component 1204 may provide, for a network node associated with the UE, embedded radio level operation configuration information in a sensing session specific container.

The transmission component 1204 may provide, to a network node, a third request to establish the sensing service between the network node and the UE.

The reception component 1202 may receive a first request associated with a communication session associated with a UE wherein the first request is associated with one or more first communication session parameters. The reception component 1202 may receive, from a second core network entity, a second request to establish a virtual communication session associated with the UE wherein the second request is associated with one or more second communication session parameters, and wherein the virtual communication session corresponds to a sensing service. The transmission component 1204 may provide, to a network node, information indicating the one or more first communication session parameters for the communication session and the one or more second communication session parameters for the virtual communication session.

The reception component 1202 may receive, from the second core network entity and embedded in a sensing session specific container, radio level operation configuration information for the network node.

The transmission component 1204 may provide, to the network node, the radio level operation configuration information.

The reception component 1202 may receive information indicating one or more policies for managing the virtual communication session as the sensing service.

The transmission component 1204 may provide, to the network node, sensing information indicating that the virtual communication session is for the sensing service, to be established between the network node and the UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include one or more of a determination component 1308 or an adjustment component 1310, among other examples.

In some aspects, the apparatus 1300 may be configured to perform one or more operations described herein in connection with FIGS. 4-8. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The reception component 1302 may receive, from a first core network entity, a first request associated with initiation of a sensing service associated with a UE wherein the first request includes information identifying one or more sensing session parameters associated with the sensing service. The determination component 1308 may determine, based at least in part on the one or more sensing session parameters and one or more communication session parameters associated with a communication session between the UE and the network node, one or more resources for the sensing service. The transmission component 1304 may transmit, to the UE, information identifying the one or more resources for the sensing service.

The reception component 1302 may receive, from a second core network entity, a second request including the one or more communication session parameters.

The transmission component 1304 may transmit, to the UE and based at least in part on the one or more sensing session parameters, one or more beam parameters to be used for the sensing service.

The adjustment component 1310 may adjust the one or more sensing session parameters.

The transmission component 1304 may transmit, to at least one of the first core network entity or a second core network entity, information indicating an adjustment to the one or more sensing session parameters.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a first core network entity, comprising: receiving a first request associated with initiation of a sensing service associated with a UE; receiving, from at least one other core network entity and based at least in part on the first request, one or more sensing session parameters associated with the sensing service; and providing, to a second core network entity and based at least in part on the sensing session parameters, a second request to establish a virtual communication session with the UE, the request including one or more communication session parameters.

Aspect 2: The method of Aspect 1, further comprising: mapping the one or more sensing session parameters to the one or more communication session parameters.

Aspect 3: The method of any of Aspects 1-2, wherein the one or more sensing session parameters include at least one of: a sensing type parameter, a range parameter, a range resolution parameter, a velocity parameter, a velocity resolution parameter, an azimuth field of view parameter, an angular resolution parameter, a maximum number of detected targets, a data rate parameter, or a latency parameter.

Aspect 4: The method of any of Aspects 1-3, wherein the one or more communication session parameters include at least one of: a quality of service parameter, an SINR parameter, a data rate parameter, or a latency parameter.

Aspect 5: The method of any of Aspects 1-4, wherein the one or more sensing session parameters are based at least in part on at least one of: subscription information associated with the UE and the sensing service, or policy information associated with the sensing service.

Aspect 6: The method of any of Aspects 1-5, wherein the first core network entity comprises an N-SMF and the second core network entity comprises an SMF.

Aspect 7: The method of any of Aspects 1-6, wherein the at least one other core network entity comprises at least one of: an N-PCF or a UDM.

Aspect 8: The method of any of Aspects 1-7, wherein the first request is received from an AMF.

Aspect 9: The method of any of Aspects 1-8, wherein the first request is associated with a sensing network slice that indicates the first request is for the sensing service.

Aspect 10: The method of any of Aspects 1-9, wherein the first request is associated with a DNN or APN that indicates the first request is for the sensing service.

Aspect 11: The method of any of Aspects 1-10, wherein receiving the one or more sensing session parameters comprises: receiving information indicating one or more policies for managing the sensing service.

Aspect 12: The method of Aspect 11 wherein the information indicating the one or more policies is based at least in part on information that identifies a location of the UE.

Aspect 13: The method of Aspect 11, wherein the information indicating the one or more policies is received from an N-PCF entity.

Aspect 14: The method of any of Aspects 1-13, further comprising: determining, based at least in part on the sensing session parameters, a communication service type for the virtual communication session; and indicating, to the second core network entity, that the virtual communication session is associated with the communication service type.

Aspect 15: The method of Aspect 14, wherein the communication service type is associated with at least one of: V2X communications or UAV communications.

Aspect 16: The method of any of Aspects 1-15, further comprising: providing, for a network node associated with the UE, embedded radio level operation configuration information in a sensing session specific container.

Aspect 17: The method of any of Aspects 1-16, further comprising: providing, to a network node, a third request to establish the sensing service between the network node and the UE.

Aspect 18: The method of Aspect 17, wherein the third request includes information indicating whether the sensing service is for a radar service or positioning service.

Aspect 19: The method of Aspect 17, wherein the third request includes information indicating the one or more sensing session parameters.

Aspect 20: The method of Aspect 17, wherein the third request includes information indicating whether the sensing service is for UE-based sensing or network node-based sensing.

Aspect 21: The method of Aspect 17, wherein the third request includes information indicating a priority associated with the sensing service.

Aspect 22: A method of wireless communication performed by a first core network entity, comprising: receiving a first request associated with a communication session associated with a UE, wherein the first request is associated with one or more first communication session parameters; receiving, from a second core network entity, a second request to establish a virtual communication session associated with the UE, wherein the second request is associated with one or more second communication session parameters, and wherein the virtual communication session corresponds to a sensing service; and providing, to a network node, information indicating the one or more first communication session parameters for the communication session and the one or more second communication session parameters for the virtual communication session.

Aspect 23: The method of Aspect 22, further comprising: receiving, from the second core network entity and embedded in a sensing session specific container, radio level operation configuration information for the network node; and providing, to the network node, the radio level operation configuration information.

Aspect 24: The method of Aspect 23, wherein the radio level operation configuration information is associated with at least one sensing session parameters, the at least one sensing session parameters including at least one of: a sensing type parameter, a range parameter, a range resolution parameter, a velocity parameter, a velocity resolution parameter, an azimuth field of view parameter, an angular resolution parameter, a maximum number of detected targets, a data rate parameter, or a latency parameter.

Aspect 25: The method of any of Aspects 22-24, wherein the one or more second communication session parameters include at least one of: a quality of service parameter, an SINR parameter, a data rate parameter, or a latency parameter.

Aspect 26: The method of any of Aspects 22-25, wherein the one or more second communication session parameters are based at least in part on at least one of: subscription information associated with the UE and the sensing service, or policy information associated with the sensing service.

Aspect 27: The method of any of Aspects 22-26, wherein the first core network entity comprises an SMF and the second core network entity comprises an N-SMF.

Aspect 28: The method of any of Aspects 22-27, wherein the first request is received from an AMF.

Aspect 29: The method of any of Aspects 22-28, wherein the second request is associated with a sensing network slice that indicates the second request is for the sensing service.

Aspect 30: The method of any of Aspects 22-29, wherein the second request is associated with a DNN or APN that indicates the second request is for the sensing service.

Aspect 31: The method of any of Aspects 22-30, further comprising: receiving information indicating one or more policies for managing the virtual communication session as the sensing service.

Aspect 32: The method of any of Aspects 22-31, wherein the second request is associated with information indicating that the virtual communication session is associated with a communication service type.

Aspect 33: The method of Aspect 32, wherein the communication service type is associated with at least one of: V2X communications, or UAV communications.

Aspect 34: The method of any of Aspects 22-33, further comprising: providing, to the network node, sensing information indicating that the virtual communication session is for the sensing service, to be established between the network node and the UE.

Aspect 35: The method of Aspect 34, wherein the sensing information includes information indicating whether the sensing service is for a radar service or positioning service.

Aspect 36: The method of Aspect 34, wherein the sensing information includes information indicating one or more sensing session parameters.

Aspect 37: The method of Aspect 34, wherein the sensing information includes information indicating whether the sensing service is for UE-based sensing or network node-based sensing.

Aspect 38: The method of Aspect 34, wherein the sensing information includes information indicating a priority associated with the sensing service.

Aspect 39: A method of wireless communication performed by a network node, comprising: receiving, from a first core network entity, a first request associated with initiation of a sensing service associated with a UE, wherein the first request includes information identifying one or more sensing session parameters associated with the sensing service; determining, based at least in part on the one or more sensing session parameters and one or more communication session parameters associated with a communication session between the UE and the network node, one or more resources for the sensing service; and transmitting, to the UE, information identifying the one or more resources for the sensing service.

Aspect 40: The method of Aspect 39, further comprising: receiving, from a second core network entity, a second request including the one or more communication session parameters.

Aspect 41: The method of Aspect 40, wherein the first core network entity is an N-SMF and the second core network entity is an SMF.

Aspect 42: The method of any of Aspects 39-41, wherein the one or more resources for the sensing service are associated with a first frequency range, and wherein one or more other resources for the communication session are associated with a second frequency range.

Aspect 43: The method of any of Aspects 39-42, wherein determining the one or more resources for the sensing service comprises: determining the one or more resources based at least in part on other resources associated with at least one other sensing service associated with at least one other UE.

Aspect 44: The method of any of Aspects 39-43, further comprising: transmitting, to the UE and based at least in part on the one or more sensing session parameters, one or more beam parameters to be used for the sensing service.

Aspect 45: The method of any of Aspects 39-44, wherein the one or more resources for the sensing service are joint communication and sensing resources associated with the communication session.

Aspect 46: The method of any of Aspects 39-45, further comprising: adjusting the one or more sensing session parameters; and transmitting, to at least one of the first core network entity or a second core network entity, information indicating an adjustment to the one or more sensing session parameters.

Aspect 47: The method of any of Aspects 39-46, wherein determining the one or more resources comprises: determining a first portion of joint communication and sensing resources for the sensing service; determining a second portion of the joint communication and sensing resources for the communication session; and determining, as the one or more resources, the first portion of the joint communication and sensing resources.

Aspect 48: An apparatus for wireless communication at a device, comprising a processor; memory coupled with the processor; and instructions stored in the memory and executable by the processor to cause the apparatus to perform the method of one or more of Aspects 1-21.

Aspect 49: An apparatus for wireless communication at a device, comprising a processor; memory coupled with the processor; and instructions stored in the memory and executable by the processor to cause the apparatus to perform the method of one or more of Aspects 22-38.

Aspect 50: An apparatus for wireless communication at a device, comprising a processor; memory coupled with the processor; and instructions stored in the memory and executable by the processor to cause the apparatus to perform the method of one or more of Aspects 39-47.

Aspect 51: A device for wireless communication, comprising a memory and one or more processors coupled to the memory, the one or more processors configured to perform the method of one or more of Aspects 1-21.

Aspect 52: A device for wireless communication, comprising a memory and one or more processors coupled to the memory, the one or more processors configured to perform the method of one or more of Aspects 22-38.

Aspect 53: A device for wireless communication, comprising a memory and one or more processors coupled to the memory, the one or more processors configured to perform the method of one or more of Aspects 39-47.

Aspect 54: An apparatus for wireless communication, comprising at least one means for performing the method of one or more of Aspects 1-21.

Aspect 55: An apparatus for wireless communication, comprising at least one means for performing the method of one or more of Aspects 22-38.

Aspect 56: An apparatus for wireless communication, comprising at least one means for performing the method of one or more of Aspects 39-47.

Aspect 57: A non-transitory computer-readable medium storing code for wireless communication, the code comprising instructions executable by a processor to perform the method of one or more of Aspects 1-21.

Aspect 58: A non-transitory computer-readable medium storing code for wireless communication, the code comprising instructions executable by a processor to perform the method of one or more of Aspects 22-38.

Aspect 59: A non-transitory computer-readable medium storing code for wireless communication, the code comprising instructions executable by a processor to perform the method of one or more of Aspects 39-47.

Aspect 60: A non-transitory computer-readable medium storing a set of instructions for wireless communication, the set of instructions comprising one or more instructions that, when executed by one or more processors of a device, cause the device to perform the method of one or more of Aspects 1-21.

Aspect 61: A non-transitory computer-readable medium storing a set of instructions for wireless communication, the set of instructions comprising one or more instructions that, when executed by one or more processors of a device, cause the device to perform the method of one or more of Aspects 22-38.

Aspect 62: A non-transitory computer-readable medium storing a set of instructions for wireless communication, the set of instructions comprising one or more instructions that, when executed by one or more processors of a device, cause the device to perform the method of one or more of Aspects 39-47.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first core network entity, comprising:
one or more memories; and
one or more processors, coupled to the one or more memories, configured to:
receive a first request associated with initiation of a sensing service associated with a user equipment (UE);
receive, from at least one other core network entity and based at least in part on the first request, one or more sensing session parameters associated with the sensing service; and
provide, to a second core network entity and based at least in part on the sensing session parameters, a second request to establish a virtual communication session with the UE, the request including one or more communication session parameters.

2. The first core network entity of claim 1, wherein the one or more processors are further configured to:
map the one or more sensing session parameters to the one or more communication session parameters.

3. The first core network entity of claim 1, wherein the one or more sensing session parameters include at least one of:
a sensing type parameter,
a range parameter,
a range resolution parameter,
a velocity parameter,
a velocity resolution parameter,
an azimuth field of view parameter,
an angular resolution parameter,
a maximum number of detected targets,
a data rate parameter, or
a latency parameter.

4. The first core network entity of claim 1, wherein the one or more communication session parameters include at least one of:
a quality of service parameter,
a signal-to-interference-plus-noise ratio (SINR) parameter,
a data rate parameter, or
a latency parameter.

5. The first core network entity of claim 1, wherein the one or more sensing session parameters are based at least in part on at least one of:
subscription information associated with the UE and the sensing service, or
policy information associated with the sensing service.

6. The first core network entity of claim 1, wherein the first core network entity comprises a non-communication session management function (N-SMF) entity and the second core network entity comprises a session management function (SMF) entity.

7. The first core network entity of claim 1, wherein the at least one other core network entity comprises at least one of:
a non-communication policy control function (N-PCF) entity, or
a unified data management (UDM) entity.

8. The first core network entity of claim 1, wherein the first request is received from an access and mobility management function (AMF) entity.

9. The first core network entity of claim 1, wherein the first request is associated with a sensing network slice that indicates the first request is for the sensing service.

10. The first core network entity of claim 1, wherein the first request is associated with a dynamic network name (DNN) or access point name (APN) that indicates the first request is for the sensing service.

11. The first core network entity of claim 1, wherein the one or more processors, to receive the one or more sensing session parameters, are configured to:
receive information indicating one or more policies for managing the sensing service.

12. The first core network entity of claim 11, wherein the information indicating the one or more policies is based at least in part on information that identifies a location of the UE.

13. The first core network entity of claim 11, wherein the information indicating the one or more policies is received from a non-communication policy control function (N-PCF) entity.

14. The first core network entity of claim 1, wherein the one or more processors are further configured to:
determine, based at least in part on the sensing session parameters, a communication service type for the virtual communication session; and
indicate, to the second core network entity, that the virtual communication session is associated with the communication service type.

15. The first core network entity of claim 14, wherein the communication service type is associated with at least one of:
vehicle-to-everything (V2X) communications, or
unmanned autonomous vehicle (UAV) communications.

16. The first core network entity of claim 1, wherein the one or more processors are further configured to:
provide, for a network node associated with the UE, embedded radio level operation configuration information in a sensing session specific container.

17. The first core network entity of claim 1, wherein the one or more processors are further configured to:
provide, to a network node, a third request to establish the sensing service between the network node and the UE.

18. The first core network entity of claim 17, wherein the third request includes information indicating whether the sensing service is for a radar service or positioning service.

19. The first core network entity of claim 17, wherein the third request includes information indicating the one or more sensing session parameters.

20. The first core network entity of claim 17, wherein the third request includes information indicating whether the sensing service is for UE-based sensing or network node-based sensing.

21. The first core network entity of claim 17, wherein the third request includes information indicating a priority associated with the sensing service.

22. A first core network entity, comprising:
one or more memories; and
one or more processors, coupled to the one or more memories, configured to:
receive a first request associated with a communication session associated with a user equipment (UE),
wherein the first request is associated with one or more first communication session parameters;
receive, from a second core network entity, a second request to establish a virtual communication session associated with the UE,
wherein the second request is associated with one or more second communication session parameters, and
wherein the virtual communication session corresponds to a sensing service; and
provide, to a network node, information indicating the one or more first communication session parameters for the communication session and the one or more second communication session parameters for the virtual communication session.

23. The first core network entity of claim 22, wherein the one or more processors are further configured to:
receive, from the second core network entity and embedded in a sensing session specific container, radio level operation configuration information for the network node; and
provide, to the network node, the radio level operation configuration information.

24. The first core network entity of claim 22, wherein the first core network entity comprises a session management function (SMF) entity and the second core network entity comprises a non-communication session management function (N-SMF) entity.

25. The first core network entity of claim 22, wherein the one or more processors are further configured to:
provide, to the network node, sensing information indicating that the virtual communication session is for the sensing service, to be established between the network node and the UE.

26. The first core network entity of claim 25, wherein the sensing information includes information indicating one or more sensing session parameters.

27. A network node, comprising:
one or more memories; and
one or more processors, coupled to the one or more memories, configured to:
receive, from a first core network entity, a first request associated with initiation of a sensing service associated with a user equipment (UE),
wherein the first request includes information identifying one or more sensing session parameters associated with the sensing service;
determine, based at least in part on the one or more sensing session parameters and one or more communication session parameters associated with a communication session between the UE and the network node, one or more resources for the sensing service; and
transmit, to the UE, information identifying the one or more resources for the sensing service.

28. The network node of claim 27, wherein the one or more processors are further configured to:
receive, from a second core network entity, a second request including the one or more communication session parameters.

29. The network node of claim 27, wherein the one or more processors, to determine the one or more resources, are configured to:
determine a first portion of joint communication and sensing resources for the sensing service;
determine a second portion of the joint communication and sensing resources for the communication session; and
determine, as the one or more resources, the first portion of the joint communication and sensing resources.

30. A method of wireless communication performed by a first core network entity, comprising:
receiving a first request associated with initiation of a sensing service associated with a user equipment (UE);
receiving, from at least one other core network entity and based at least in part on the first request, one or more sensing session parameters associated with the sensing service; and
providing, to a second core network entity and based at least in part on the sensing session parameters, a second request to establish a virtual communication session with the UE, the second request including one or more communication session parameters.
